(19) United States
(12) Patent Application Publication
(10) Pub. No.: US 2008/0162228 A1
(43) Pub. Date: Jul. 3, 2008

(54) Method and system for the integrating advertising in user generated contributions

(76) Inventors: Friedrich Mechbach, Salzburg (AT); Angelika Haenssler, Dettenhausen (DE)

Correspondence Address: TROUTMAN SANDERS LLP, 600 PEACHTREE STREET , NE, ATLANTA, GA, 30308, US

(21) Appl. No.: 12/002,835

(22) Filed: Dec. 19, 2007

Related U.S. Application Data
(60) Provisional application No. 60/870,817, filed on Dec. 19, 2006.

(51) Int. Cl. G06F 17/00; G06Q 30/00

(52) U.S. Cl. 705/7; 705/1; 705/14

(57) ABSTRACT

The invention is to a method of generating user contribution such as a video or slide presentation that incorporates both images and sounds. The method may include integrating an advertisement into a user generated contribution for posting on a communication network. The advertising may be used to pay video generation, copyright license, web hosting, or any other fees that may be due for creating and viewing the user generated contribution. The invention is also directed to a computer system configured to generate a user generated contribution by integrating files from a user library of personal electronic data files, a copyright protected library of electronic data files protected by copyright, and advertisement library of advertisements. The computer system may be configured to analyze at least one electronic data file protected by copyright to determine appropriate transition points or create a image file template.

This application claims priority under 35 U.S.C. §119(e) to U.S. Provisional Patent Application Ser. No. 60/870,817 filed on Dec. 19, 2006.

### TECHNICAL FIELD OF THE INVENTION

Embodiments of the invention relate to a method, apparatus, and software for combining copyright protected material owned by another with at least one video, photograph, slideshow, movie, animation, presentation, text file, or other image and obtaining a license for use or display of the copyright protected material.

### BACKGROUND OF THE INVENTION

The worldwide web has developed into a computer network that allows people to contact one another and share electronic media such as music, messages, photographs, videos, animating and other images, for example. Many web sites and community portals have been established for storing this electronic media and making it accessible to anyone with an internet connection, alternatively access to the electronic media may be restricted by password to a certain limited group of potential viewers. The World wide web has converged with other platforms, devices such as the mobile internet, and IPTV. All further description of “Online” and “community portals” include these newly emerging convergent networks, platforms and public communities.

On line and community portals at the present time may have difficulty generating significant profits. Income to an online or community portal results almost exclusively from advertising receipts, though some web sites may have membership or subscription fees for membership or use of advanced features. However, “pop-up” and banner advertising fees are the primary way of supporting such web sites. The fees may be based upon the number of times a page or profile is viewed or the number of times an advertisement is actually clicked on to take a viewer to the advertisers, or other sellers, web site. Typically, the advertising fees support the web site and users may, therefore, post and view online content and user generated contributions for free.

Such advertising may be targeted by the advertiser on some web sites such as an outdoor supply store may advertise on sites that provide content concerning hunting and fishing. However, it is more difficult to determine the value of advertising on more general web sites that attract users that post and view any content or a variety of topics. This advertising is widely scattered, unfocused, and is received by every person who visits the page. This advertising is comparable in effect with that in newspaper advertisements on TV and in other media or a billboard on the side of the road. With this type of advertising, the user or reader is a passive observer, without being able to exert influence on the advertising itself, with regard to the product being advertised or the nature of the advertising.

On community portals, the content and user contributions to the portal are predominantly designed by the users themselves (user generated contribution), in which the users add their own contributions to the portal. These contributions may include music, videos, messages, photographs, animations, slideshows, as well as other electronic media. Presently, it is difficult for advertisers to target such users with focused advertising.

Additionally and unfortunately, users may publish their own contributions that include copyright protected works that have not been properly licensed for such use. For example, a song may be attached to a slideshow of photographs or a home video to produce a more professional contribution. However, frequently users do not have a license for such use of the copyright protected material. More and more frequently, owners of copyright protected material are enforcing their rights and preventing such use. In addition, due to potential liability owners of web sites and community portals are implementing software solutions that prevent or at least identify postings that include unlicensed copyrighted material on their sites. Additionally, negotiating licenses for use of licenses with the large number and disperse users is too onerous for owners of copyrighted materials.

There exists a need for methods, software, and apparatuses that allow incorporation of more focused advertising on web sites and community portals. There is also a need for methods, software and apparatuses that allow users to legally incorporate copyright protected material into a users' contribution by obtaining a license and/or compensating the owner of the copyright protected material for its use.

### SUMMARY OF THE INVENTION

Embodiments of the invention are directed to a method of generating user contribution, such as a video or slide presentation that incorporates both images and sounds. Embodiments of the method comprise integrating an advertisement into a user generated contribution for posting on a communication network. The advertising may be used to pay video generation, copyright license, web hosting, or any other fees that may be due for creating and viewing the user generated contribution. Such a method may be used to legally incorporate copyright protected media into personal postings on the internet or other online community portal.

Further embodiments include a system comprising a computer system configured to generate a user generated contribution by integrating files from a user library of personal electronic data files, a copyright protected library of electronic data files protected by copyright, and advertisement library of advertisements. The computer system may be configured to analyze at least one electronic data file protected by copyright to determine appropriate transition points or create a image file template.

### BRIEF DESCRIPTION OF THE FIGURES

The invention is further described in relation to the following figures where:

FIG. 1 is a flow sheet of an embodiment of the method of the invention;

FIG. 2 is a block diagram showing a computer system configured to perform embodiments of the method of the invention;

FIG. 3 is a flow sheet showing aspects of an embodiment of the method of the invention; and

FIG. 4 is a flow sheet of a business method of the invention indicating various embodiments of methods of paying various fees from integrating an advertisement into a user generated contribution for posting on a communication network such as the world wide web or internet.

### DESCRIPTION

Embodiments of the present invention are directed to a method and system for providing user generated contributions to at least one electronic media delivery system. Embodiments of the method and system may comprise coupling an advertisement with the user generated contribution. Embodiments of the method may also comprise integrating copyright protected media into the user generated media and obtaining an appropriate license for use of the copyright protected media. In a more specific embodiment, the user generated contribution is coupled with an advertisement and comprises copyright protected media. In such an embodiment, the advertiser may pay at least a portion of the license fees required to obtain the appropriate license for the copyright protected media in exchange for the user integrating the advertisement into the contribution. By such a method the user generated contribution may be legally posted and viewed by others.

The present invention expands the interactive nature of on line/mobile and community portals by allowing the user or others to incorporate advertising and/or copyright protected material into their own contributions. Community portals such as YouTube™, Google™, Yahoo™, Flickr™, MySpace™, Facebook™, as well as many more commercial and personal web sites, are extremely popular for internet users to post contributions that the user has generated or adding a favourite song to a personal page. In addition, the user generated contribution may be distributed as a podcast, such as through iTunes™ or other podcasting services. Certain popular public forums are maintained at least partially by advertising fees for banner and pop-up advertising in general or with profiles of users with prerolls and layers around the private content, though others include a subscription fee or user fees. Embodiments of the invention comprise a computer-implemented method comprising incorporating an advertisement into a user generated contribution itself. If the contribution is downloaded emailed or shared on mobile devices, the advertisement is also downloaded, emailed or treated in the same way, therefore, the advertising has a potential of more viewings greatly increasing the value of the advertisement to the advertiser. Embodiments of the method also include integrating copyright protected media onto a personal web page and obtaining the appropriate license for use.

User generated contributions may comprise an electronic data file. Typically, user generated contributions comprise encoding of at least one digital file comprising a photograph, video, movie, text file, animation, music, sound, speech, or image file. In some cases, the user generated contribution will comprise multiple data files. Therefore, embodiments of the method of the invention comprise arranging the multiple data files into a sequence of data files. Arranging the electronic data files, therefore, may comprise making such a sequence for playing and/or displaying of the content electronic data files. In such a sequence, two or more files may be played and/or displayed simultaneously. The user generating the contribution may also indicate a position in the sequence for the advertisement, an advertising position. The advertising position may be at the end of the sequence, beginning of the sequence, anywhere between the beginning and the end. The advertisement may also be a banner on top or bottom of the contribution, a “watermark”, or be in another location in the contribution. In another embodiment, the user contribution may include a code that controls the “pop-up” and/or banner advertisement on the web site or portal. A company logo, for example, may be incorporated into a video or slideshow as a watermark. Therefore, as used herein, an “advertising position” may be a position in the sequence, on a portion of the image, or both.

The advertising may be any form of advertisement such as a data file including encoded images, sounds, or a combination of both. Embodiments of the method and apparatus of the present invention allow advertisers to use a new form of advertising. With the method of the present invention, advertising may be added to personal contributions of the on line community. In the embodiment wherein the user generator contribution is a personal video, the personal video, for example, may be emailed or copied to a storage device for viewing by friends, relatives, and acquaintances with any device comprising software or hardware configured for reading the encoded information to playback the video such as a computer, video player, television, or cell phone or in case of a public community-portal streamed by every view of the video. Some personal videos may be circulated to millions of viewers and viewed millions of times. The user generated contributions may include videos of family members, video blogs, political comments, slide show of pictures, or any other images.

The advertiser or advertisers may offer a selection of advertisements so the user can select an advertisement that they feel matches or complements the user generated contribution, such as pictures or video of a new baby with an advertisement for diapers or pictures or video of a new automobile with an advertisement from the automobile manufacturer, for example. The advertiser in this way gets access to a target group of people with similar interests. People viewing photographs of a new baby may also have a baby. Therefore, the user may select an advertisement from the library of potential advertisers whose product, service or type of advertising design that they wish to insert into the contribution.

The on line or community portal may provide the user, on line or mobile, with the choice of desired advertisers, or advertisers on a list, along with a variety of advertisement from each advertiser. The user may select an advertisement that's images, sounds or form of advertising appeals to him or he identifies with and, therefore, wishes to integrate into his contribution.

For the advertiser, this form of advertising provides at least the following advantages (a) the advertiser is present on the portal with his advertising, (b) the advertising is matched with the user and viewer, for example, the user personally selects the advertiser and their associated advertising directly in order to seek out the advertising which suits him and his contribution and may select advertising that is of interest to the potential audience, (c) the user, as soon as he chooses an advertisement, identifies himself with the advertiser, (d) the user distributes his contribution with the integrated advertisement by email link or via mobile sharing function, (e) the user publishes his contribution with the integrated advertisement on the on line or community portal, such as by uploading, and so disseminates the advertisement with the option that the contribution is freely copied and subsequently further distributed or streamed by each viewing of his contribution, (f) the advertising and user contribution may, in some circumstances, be tracked such that the advertiser knows how often the video provided with his advertisement is viewed or sent and by whom, (g) the advertiser can monitor and determine which advertisement is being well-received by which users and which are not, and is therefore in a position to evaluate the inherent quality of his advertising, (h) in some cases, the user may pay for use of a particularly popular advertisement, and (i) the advertiser may also request approval of a user's contribution prior to publication and, if desired, may block his advertising within the contribution.

For the user, this type of advertising has the advantage that (a) he can seek out an advertisement and the user from being the simple object of the advertisement to being a joint creator, (b) by incorporating the advertisement into his contribution he is making it known to the outside with which product he endorses, (c) the video generation is free of charge because the advertiser pays the fee for the video generation and the copyright license, (d) he can receive an emolument from the advertiser, such as a monetary payment, in return for the integration of the advertisement in the user's contribution, (e) the user may select from many advertisers and advertisements without having to negotiate advertising rates, and (f) the user may incorporate copyright protected material into their contribution and have the advertiser pay any applicable licensing fees necessary to avoid infringement of the copyright.

The on line or community portal may receive additional benefits to the site such as (a) newly-generated traffic interested in the user contributions and users interested in obtaining advertising revenue, (b) increased advertising revenue due to better qualified customer response, since the value assessment provided by an advertisement selected by the user may be classified for a higher fee than passively observed advertising, and (c) increased advertising revenue to the portal may be acquired by the further recommendation of a brand name or a product and as participation in the fees levied and paid for the incorporation of the advertisement.

One embodiment of the method of the invention comprises coupling a file comprising a tone sequence, such as a song, music, instrumental, voice recording, speech, discussion, or a combination of such elements, and at least one data file, such as a video, photograph, or other image, for the reproduction by means of a playback device.

The invention of the method and apparatus of the present invention is described in multiple embodiments. Even though the embodiments are described separately, aspects of one embodiment may be included in the other embodiments.

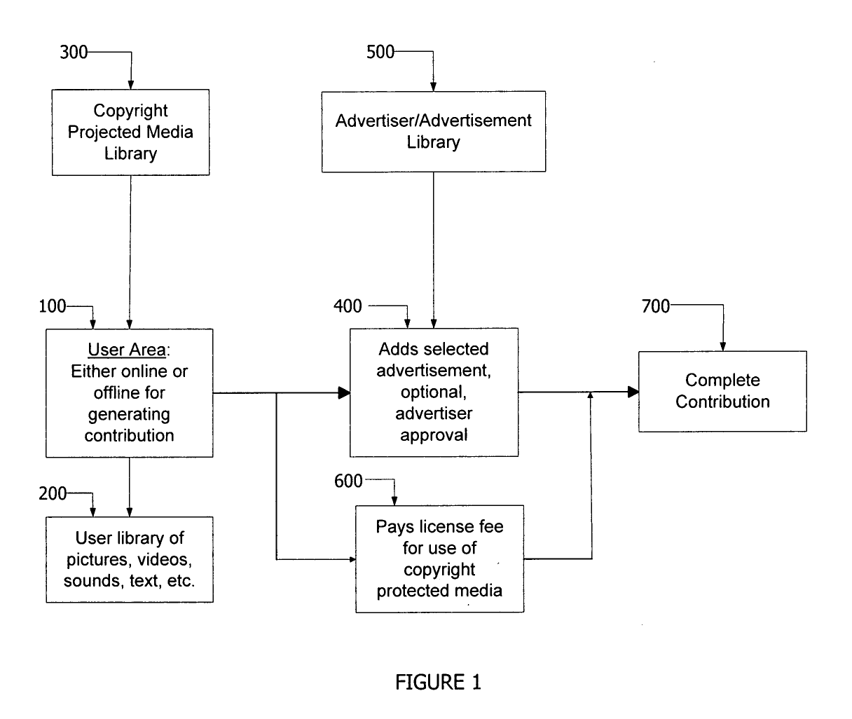

FIG. 1 depicts one embodiment of the methods and apparatuses of the present invention. Embodiments of the method of the invention include computer implemented methods. The user system 100 comprises a system configured to generate a user contribution. The user system 100 may comprise a personal computer/cell phone configured to generate the user contribution or may be a communication device on a network such as, for example, a computer connected to the internet or a mobile device in communication with a service provider. The system may be configured to analyze a song or other tone sequence to professionally integrate media from the User Library 200, as described. The user system 100 may also be configured to integrate an advertisement from an Advertisement Library 500 on the advertising system 400 into a file comprising at least one file selected from user media library. User system may also be configured to select the music, other tone sequence, photographs or other images from a Copy Right Protected Media Library 300 for use in combination with the media from the User Library 200. The system may also be configured to manage licensing of the copyright protected media by use of advertising fees or direct payment from the user in Licensing System 600. In any embodiment, the User Library and the Copyright Protected Library may include pictures, photographs, images, videos, music, sounds, voice recordings, animation, or slide shows. The User Library contains such files that the user personally has permission to use or is in the public domain and the Copyright Protected Library contains such files that must be licensed to use legally. Optionally, the compilation may be previewed by the user or the advertiser to approve the contribution. The completed contribution 700 may be posted on the community portal, personal web site, mobile platform or other network area for viewing of others.

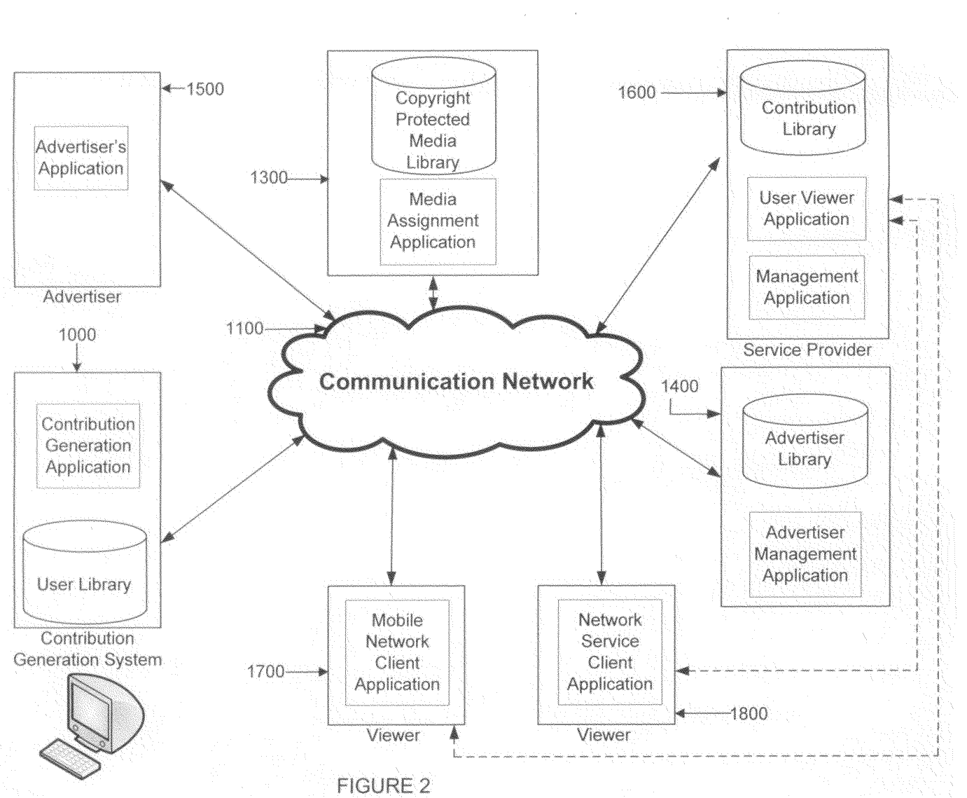

One embodiment of a system or apparatus of the present invention is shown in FIG. 2, a contribution generation system 1000 is configured to generate a contribution by having access to the User Library, a Copyright Protected Media system 1300 comprising a Copyright Protected Library, and an Advertiser System 1400 comprising an Advertiser Library. The Contribution generating system is configured to integrate the desired files from the three libraries through the Communication Network 1100 and generate the contribution. The contribution may then be posted on a web portal other community web site through the service provider 1600 where the contribution may be viewed by users. The Service Provider 1600 may track the statistics for a contribution through the Communication Network 1100 and report to the Advertiser 1500 for payment of fees which may comprise at least one of advertising fees, video generation fees, or copyright license fees. The contribution may be viewed from the Service Provided 1600 through a Mobile Network 1700 or other Network Service Client Application 1800 either directly from the Service Provider 1600 or through the communication network.

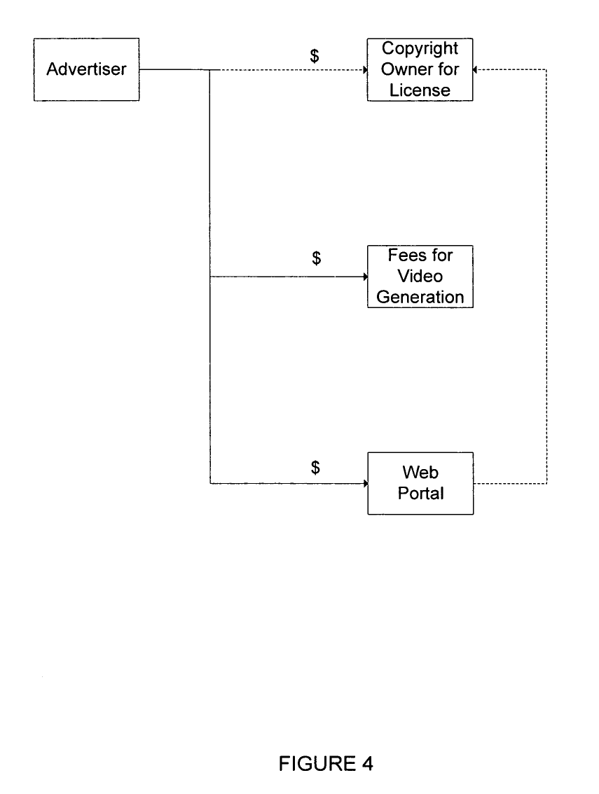

Embodiments of the present invention provide at least two methods of paying for the appropriate license for the use and copying of the copyright protected media. The user may in Step 400 add an advertisement into his compilation from the Advertiser/Advertisement Collection 500 or in Step 600 pay the appropriate license fee and video generation fee without including an advertisement. The completed compilation, with or without embedded advertising, is complete and may be added to an on line or community portal as a user generated contribution. As seen in FIG. 4, the Advertiser fees may be paid directly to the web portal for video generation and advertising fees. The fees for licensing of the Copyright Protected Media may be managed and paid directly from the advertiser or may be set up that the web portal will manage and pay the license fees.

The tone sequence or the data file sequence or both may also include at least one advertisement. The advertisement may be automatically selected by the software or selected by the user for addition to the contribution. In certain embodiments, the tone sequence could be empty, however, the preferred embodiment includes both screen and tone sequences. The screen and/or tone sequence may comprise copyright protected materials.

Preferably, the system is configured with automated video generation software such as described in German Patent No. DE 103 04 098. The computer may be configured to assist the operator in coupling a song or other tone sequence with at least one electronic media file. Automated video generating software is preferred to normal video editing software. Video editing software is available to assist in creating video clips or films. Using such software, the user may include music with a video or slide show of photographs. In order to produce professional results, however, the user must have an in-depth knowledge of the software and of video editing techniques. The process to develop this knowledge is time consuming and may be difficult even for experienced editors to get the desired results. Such software and techniques may also be used to prepare presentations in the sciences or for marketing. In typical video editing software, the screen sequences may be simple or use advanced techniques like cross-fading and may be considered a slide show by which one picture follows the next. However, the music may not easily be synchronized with the sequences of images or videos, creating unprofessional results. Most often the tone sequence is added unsynchronized with the sequence of other data files. Therefore, though it is possible to produce slide shows or videos for uploading onto an on line or community portal, it is more difficult to produce a fluid synchronized presentation of pictures/video sequences and music with a professional audio or sense based film cut.

Automated video generation software, as used herein, enables a user to produce video combining images synchronized with music in a professional manner. Such video generation software analyzes the music or other tone sequence to determine appropriate places to transition from one image to another in the image sequence and may, for example, generate a file or code, a placeholder, for locating these transitions. The image sequence is then synchronized with the music or other tone sequence through these transition points. In one embodiment, the method comprises usage of video generation software on an appropriate data processing apparatus. The automated video generation software may be used over a communication network such as, for example, a local area network, a wireless network, or the world wide web (“internet”) or alternatively may be downloaded from the internet, installed from a compact disc (“CD”) or otherwise installed or copied to the appropriate data processing apparatus or computer.

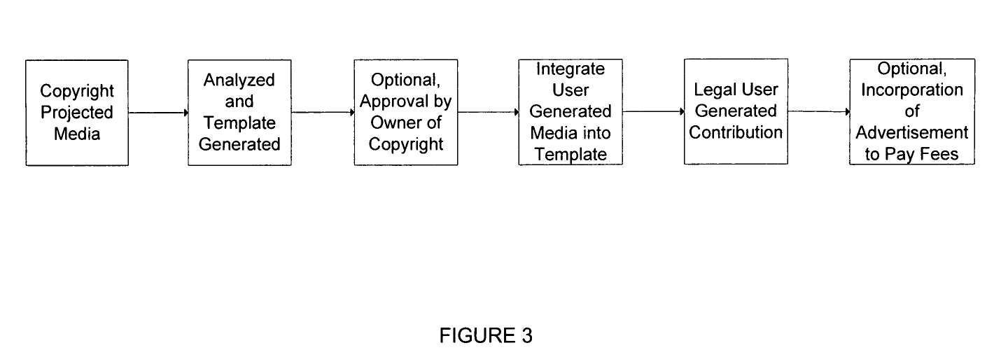

In a preferred embodiment as shown generally in FIG. 3, video generation software analyzes the music or other tone sequence according to user or otherwise defined conditions to determine appropriate image transition points. In the embodiment of FIG. 3, the music is copyright protected. During analysis, the defined conditions are automatically recognized in the music or other tone sequence, and a placeholder is defined to indicate a transition from one image to the next is to occur at the point meeting the defined conditions or the transition at that point is merely suggested to the user. A template may be generated so the transition points may be used for additional image sequences. The timing of the transition points or placeholders may also be simply time-controlled, such that the change from one image to the next is controlled at a time interval, which may be entered in the control menu, or just accepted as defined in the software. The image sequence from the user's library, the copyright material library, or the advertiser's library may be chosen by the user or images may be selected randomly from the user library by the software. Optionally, the copyright owner may be requested to approve the template for further use with his copyright protected media.

Normally, a change of a characteristic in the music or other tone sequence determines when the transition from one picture to the next is to occur, such as when a defined characteristic achieves a certain value. A change in a tone sequence may be, for example, defined in a way that the spoken word of a female is recognized as different to that of a man; or that music may be separated with transition points by changes in style, tempo, rhythm, volume, chords, pitch, speed, key, dynamic instruction, metric data, or by the presence of certain music instruments. Several software programs for example Mufin Music Finder, Tunatic, Musicline or Songtapper are available to analyze songs, speech, and/or other tone sequences.

These properties of music or other tone sequence can be defined as search criteria, according to which the music or other tone sequences may be searched automatically. In an example, the digital photographs of a child birthday party can be arranged into a nice video. One or more birthday songs, or portions of birthday songs, could be analyzed to determine appropriate transition points in the songs then the digital photographs are integrated to transition from one photograph to another at the transition points by the computer implemented method. Of course, a portion of a song may be used in embodiments of the invention. In order to further develop the video of images, the user may add “transitions,” effects, animations, etc., that control how one picture, video, or other image sequence disappears and the next appears, such as are well known in the art or may manually add additional transition points.

Analogously, it is possible to integrate music or other tone sequence with a picture sequence. Individual music pieces, discussions, dialogues or other noises can be automatically matched to the picture sequence by image parameters including, but not limited to, color changes, image transition, changes in a slide show and brightness changes. Thus, a noise can be faded out slowly, music may then play and transition into gentle sea noise and end with some noisy chords in an embodiment. If the user took some digital photos, for example, he can then store these photos simply in a picture file and connect them with the cycle of a stored tone sequence.

The user contribution may be prepared by the video generation software and can be played on a television set, a computer, personal video player such as portable DVD player or iPod™, or a suitable mobile telephone. Also, the design of a home page or part of a home page can be completed efficiently, attractively, and creatively. For embodiments wherein the video generation software is on a local computer or editing device, software which contains the program for the control of the tone sequence or the user generated contribution may be transferred on a CD-ROM, suitable data communication, magnetic disks, over a communication network, or by other data carrier.

In the preferred embodiment, the user selects from available transition points in his contribution for placement of an advertisement, at an advertisement position. The system is configured to offer the user, independently, the choice of advertising from all available advertisers available in the Advertiser Library. See FIG. 3, for optional step of incorporation of advertising into the contribution.

In any of the embodiments, the method and system includes an Advertisement Management Application that allows management of the Advertisers Library including access to the table or selection of advertisers, in such a way that any desired advertising contributions can be added, removed, edited, or replaced. The advertisements can also be subdivided into particular categories, so that specific categories can be allocated only to contributions with specific contents or forms from the user. In addition, it is made possible for the web page or portal operators or their authorized representative to provide the advertising contributions themselves with notes regarding user behavior, e.g., blocking markers for certain users, or prices. The user can make his choice with regard to the advertising messages correspondingly, according to categories, high or low prices or price credits, advertising recommendations, or blocking markers for specific user contributions. In this situation, specific observations and notes from the web page or portal operators can have a mandatory property for the user, such as blocking markers, and must be followed by the user. The advertisers may also require approval prior to posting of the user generated contribution integrating their advertisement. The application may allow selection of advertisements by clicking on a button which is allocated to an advertising message, by means of “drag and drop”, or by way of another selection criterion.

In certain embodiments, the method may include and the system may be configured such that the transition point in the user-generated contribution for placement of the advertisement is recognized automatically, and the advertising messages selected by the user may be integrated automatically in the desired position or positions.

In the preferred embodiment, the software is designed in such a way that the on line check can be carried out by deposited security software and/or by additional manual checking, depending on how the advertiser and/or web site or portal operator has specified this to be. In the preferred embodiment, the software is designed in such a way that, in the event of the check leading to irregularities, the contribution will not be cleared and the irregularity will be displayed to the user. In such a case, the integration of the advertisement into the contribution may be suppressed by the software.

In the embodiment, the method may comprise or the system may be configured to allow the user, advertiser, and/or the service provider to view the benefit each is receiving by integrating the advertisement, such as a one-off payment, a payment scaled depending on the number of times the contribution is called up, a free clip, number of times the contribution was viewed, and the advertising fees generated by the contribution, for example. As an alternative, the user can likewise be committed to providing a payment for the use of the advertisement.

According to the notification as to which contribution a user will receive under what conditions, the user can receive either a sponsored clip or a self-financed clip. He can download this from the on line sector and store it, send it to different devices, or put it on line. If the user wishes to participate in terms of fees on the basis of the number of hits, then he must leave the web site or portal on line, so that he can determine the number of hits to the advertiser via the portal or web page operator. The user can then, depending on the number of hits, receive remuneration on the part of the advertiser and/or the portal operator. If other users wish to download the contribution, then, if appropriate, a new remuneration may be effected on the part of the advertiser and/or portal operator.

A number of embodiments of the methods and systems of the invention have been described individually, however, it is understood that components of one embodiment may be incorporated into the various other embodiments described. Further, it will be understood that various modifications may be made without departing from the spirit or scope of the invention. Accordingly, other embodiments are within the scope of the following claims.

1. A method of generating user contribution, comprising
integrating an advertisement into a user generated contribution for posting on a communication network.

2. The method of claim 1, wherein the user generated contribution comprises copyright protected media.

3. The method of claim 2, wherein the copyright protected media is at least one of a song, tone sequence, a film, a video, or music-video.

4. The method of claim 3, comprising analyzing the copyright protected media according to defined properties to find transition points.

5. The method of claim 4, wherein the user generated contribution comprises at least one electronic data file selected from files encoding a photograph, video, movie, text file, animation, music, sound, speech, or other usage file.

6. The method of claim 5, wherein at least one media file and the advertisement are placed according to the transition points.

7. The method of claim 6, wherein the user contribution comprises a plurality of additional electronic data files.

8. The method of claim 2, wherein integrating the advertisement pays any fees for use of the copyright protected media.

9. The method of claim 4, wherein the analyzing is a copyright implemented method of analyzing the copyright protected media for changes in at least one of pitch, volume, tempo, rhythm, instruments, voices, chords, or key to determine transition points for electronic data files.

10. A system, comprising
a computer system configured to generate a user generated contribution by integrating files from a user library of personal electronic data files, a copyright protected library of electronic data files protected by copyright, and advertisement library of advertisements.

11. The system of claim 10, wherein the electronic data files protected by copyright comprise at least one of a song or tone sequence, a film, or a video.

12. The system of claim 11, wherein the computer system is configured to analyze at least one electronic data file protected by copyright according to defined properties to determine transition points.

13. The system of claim 12, the personal electronic data files are files encoding a photograph, video, movie, text file, animation, music, sound, speech, or other usage file.

14. The system of claim 13, wherein the computer system is configured to integrate at least one personal electronic data file and the advertisement according to the transition points.

15. The system of claim 14, wherein the computer system is configured to integrate a plurality of a plurality of personal electronic data files.

16. The system of claim 15, wherein the computer system is configured to integrate the advertisement and monitor use of the copyright protected media.

17. The system of claim 16, wherein the analyzing the copyright protected media comprises analyzing the copyright protected media for changes in at least one of pitch, volume, tempo, rhythm, instruments, voices, chords, or key to determine transition points for electronic data files.
